(19) United States
(12) Patent Application Publication
(10) Pub. No.: US 2019/0234500 A1
(43) Pub. Date: Aug. 1, 2019

(54) LINEAR ACTUATOR INCLUDING OUTER HOUSING

(71) Applicant: Schaeffler Technologies AG & Co. KG, Herzogenaurach (DE)

(72) Inventors: Joseph Johnson, Mooresville, NC (US); Craig Hooker, Indian Land, SC (US)

(73) Assignee: Schaeffler Technologies AG & Co. KG, Herzogenaurach (DE)

(21) Appl. No.: 15/880,942

(22) Filed: Jan. 26, 2018

(51) Int. Cl. F16H 25/22; F16H 25/20

(52) U.S. Cl. CPC F16H 25/2252; F16H 25/2015; F16H 2025/2078; F16H 2025/2031; F16H 2025/204

(57) ABSTRACT

A linear actuator drive arrangement is disclosed. The arrangement includes a linear actuator assembly including a motor, a drive screw arranged within the motor that is axially driven by the motor, and a linear actuator housing surrounding the motor. An outer housing surrounds the linear actuator housing. The outer housing is fixed to the drive screw and axially slides relative to the linear actuator housing when the drive screw is axially driven by the motor. An anti-rotation retainer is arranged between the linear actuator housing and the outer housing that (1) provides an axial end stop for an extended position of the outer housing located between the outer housing and the linear actuator housing, and (2) prevents relative rotation between the linear actuator housing and the outer housing.

### FIELD OF INVENTION

This invention is generally related to a linear actuator.

### BACKGROUND

Linear actuators are well known and include a variety of configurations. Some linear actuators include telescoping features, such as disclosed in U.S. Pat. Nos. 8,286,520 and 8,794,085. Other known types of linear actuators attempt to provide a compact arrangement, but require complex drive mechanisms, such as disclosed in U.S. Pat. No. 6,794,779. Another type of linear actuator requires a gearbox, such as disclosed in U.S. Pat. No. 4,579,012. However, this type of arrangement increases the overall axial length of the assembly, reduces efficiency, and introduces additional failure modes. An additional type of linear actuator is disclosed in U.S. Pat. No. 5,099,161. This type of linear actuator is incapable of handling high loads due to a relatively low mechanical advantage of its ball screw assembly.

It would be desirable to provide a compact and efficient linear actuator that is capable of supporting a high load and is also durable.

### SUMMARY

Briefly stated, an improved linear actuator drive arrangement including an outer housing is provided. The linear actuator drive arrangement includes a linear actuator assembly including a motor, a drive screw arranged within the motor that is axially driven by the motor, and a linear actuator housing surrounding the motor. The outer housing surrounds the linear actuator housing, the outer housing is fixed to the drive screw, and the outer housing axially slides relative to the linear actuator housing when the drive screw is axially driven by the motor. An anti-rotation retainer is arranged between the linear actuator housing and the outer housing that (1) provides an axial end stop for an extended position of the outer housing located between the outer housing and the linear actuator housing, and (2) prevents relative rotation between the linear actuator housing and the outer housing.

Preferred arrangements with one or more features of the invention are described below and in the claims.

### BRIEF DESCRIPTION OF THE DRAWINGS

The foregoing summary as well as the following detailed description will be best understood when read in conjunction with the appended drawings. In the drawings:

FIG. 1 is a side view in cross section of a linear actuator drive arrangement according to one embodiment.

FIG. 2 is a side view in cross section of the linear actuator drive arrangement showing an outer housing surrounding a linear actuator assembly.

FIG. 3 is an additional side view in cross section of the linear actuator drive arrangement.

FIG. 4 is a top view in cross section of the linear actuator drive arrangement.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “at least one of a, b, or c” (where a, b, and c represent the items being listed) means any single one of the items a, b, c or combinations thereof. The terminology includes the words specifically noted above, derivates thereof, and words of similar import.

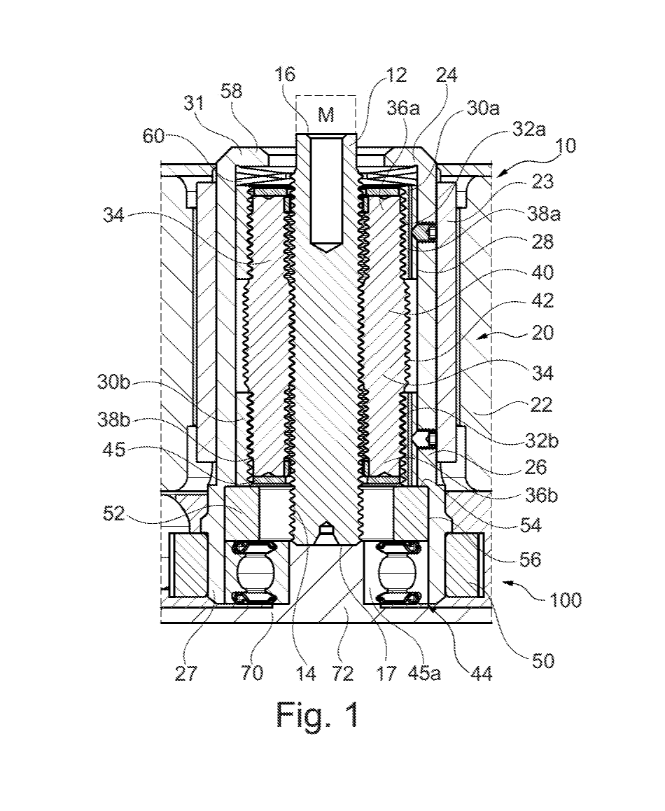

As shown in FIG. 1, a linear actuator drive arrangement 100 is disclosed. The linear actuator drive arrangement 100 includes a linear actuator assembly 10 including a motor 20, a drive screw 12 arranged within the motor 20 that is axially driven by the motor 20, and a linear actuator housing 70 surrounding the motor 20. The drive screw 12 includes a drive screw threading 14 on an outer periphery thereof. A first axial end 16 of the drive screw 12 is configured to support a load (M). The motor 20 includes a stator 22 and a rotor 24 arranged radially within the stator 22. The rotor 24 includes a rotor housing 26, and a first ring nut 30a and a second ring nut 30b. Magnets 23 of the motor 20 are directly attached to an outer surface of the rotor housing 26. The first and second ring nuts 30a, 30b are each fixed to a radially inner surface 28 of the rotor housing 26 and each include ring nut grooves 32a, 32b on an inner periphery thereof. A plurality of planetary screws 34 are arranged radially between the drive screw 12 and the first ring nut 30a and the second ring nut 30b. Each planetary screw of the plurality of planetary screws 34 includes: (1) axial ends 36a, 36b having planetary screw grooves 38a, 38b configured to engage the ring nut grooves 32a, 32b of the first ring nut 30a and the second ring nut 30b, and (2) a medial portion 40 including a planetary screw threading 42 configured to engage the drive screw threading 14 to axially drive the drive screw 12. In one embodiment, the plurality of planetary screws 34 are supported by a cage 35. An angular contact bearing assembly 44 is arranged radially inside a first axial end 27 of the rotor housing 26, and the bearing assembly 44 axially supports the rotor housing 26. An encoder ring 50 is fixed to a radially outer surface 29 of the rotor housing 26 at the first axial end 27 of the rotor housing 26, and the encoder ring 50 is concentric with the bearing assembly 44. The encoder ring 50 and the bearing assembly 44 are co-planar within a radially extending plane. The rotor housing 26 directly contacts both the encoder ring 50 and an outer ring 45b of the bearing assembly 44. A support ring 52 is arranged axially between a support shoulder 54 defined on a radially inner surface 56 of the rotor housing 26 and the bearing assembly 44. A second axial end 31 of the rotor housing 26 includes a radially inwardly extending flange 58. This radially inwardly extending flange 58 serves as a stop surface for a biasing element 60. The biasing element 60 is arranged between the radially inwardly extending flange 58 of the rotor housing 26 and the first ring nut 30a. The linear actuator housing 70 includes a support post 72 against which a second axial end 17 of the drive screw 12 abuts in a retracted position. A radially inner ring 45a of the bearing assembly 44 is mounted on the support post 72.

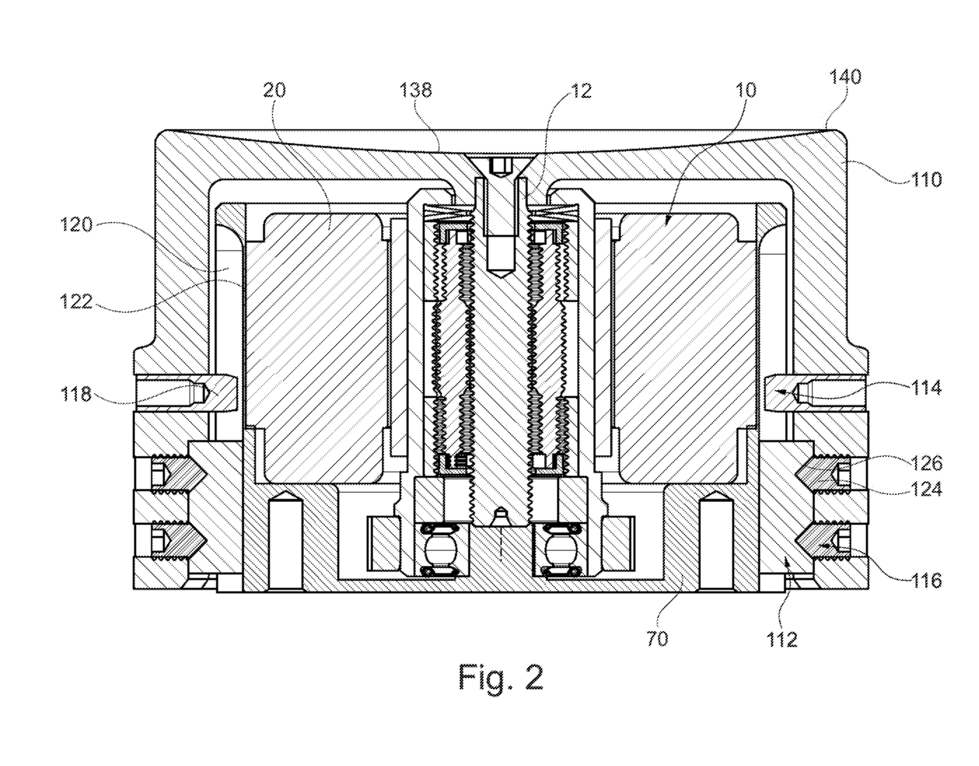

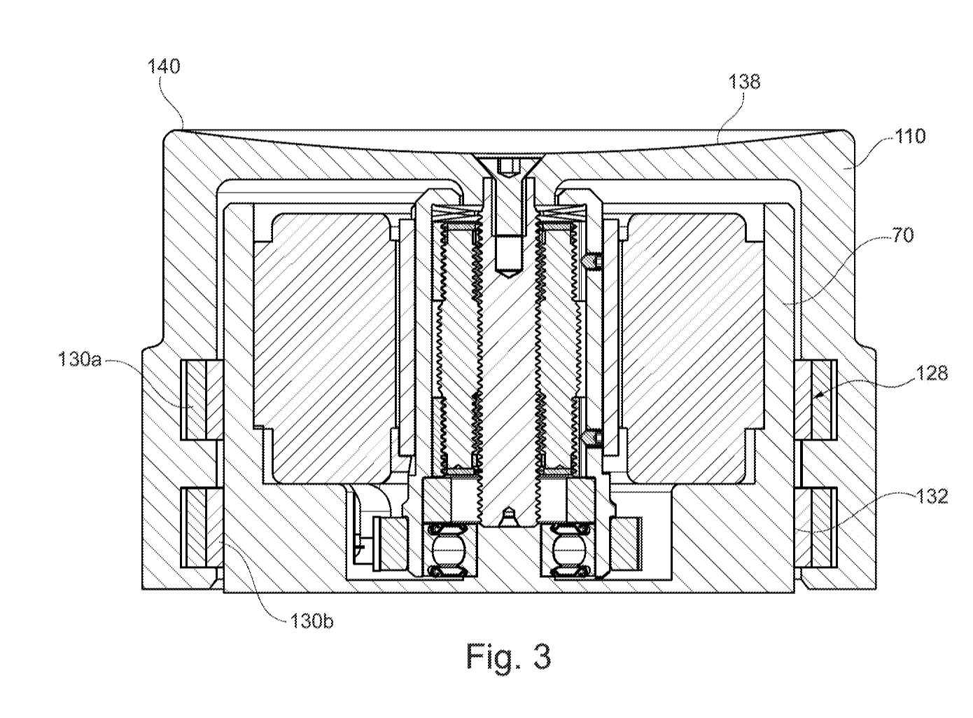

As shown more clearly in FIGS. 2 and 3, an outer housing 110 surrounds the linear actuator housing 70 and is fixed to the drive screw 12. The outer housing 110 axially slides relative to the linear actuator housing 70 when the drive screw 12 is axially driven by the motor 20. The outer housing 110 serves as an outer protection layer for the internal components of the linear actuator assembly 10, as well as an attachment interface for the drive screw 12.

As shown in FIG. 2, an anti-rotation retainer 112 is arranged between the linear actuator housing 70 and the outer housing 110 that both (1) provides an axial end stop for an extended position of the outer housing 110 located between the outer housing 110 and the linear actuator housing 70, and (2) prevents relative rotation between the linear actuator housing 70 and the outer housing 110. In one embodiment, the anti-rotation retainer 112 includes a separately formed axial retainer 114 and an anti-rotation arrangement 116. One of ordinary skill in the art would recognize from the present disclosure that the axial retainer 114 and the anti-rotation arrangement 116 could be combined into a single feature.

In one embodiment, the separately formed axial retainer 114 includes at least one bolt 118 extending radially inwardly from the outer housing 110 into at least one groove 120 defined on a radially outer surface 122 of the linear actuator housing 70. In one embodiment, the groove 120 is integrally formed on an outer surface of the linear actuator housing 70. Two grooves 120 are illustrated in FIG. 2, but one of ordinary skill in the art would recognize that additional grooves 120 can be provided on the linear actuator housing 70, as well as additional bolts 118.

The anti-rotation arrangement 116 includes (1) at least one projection 124 formed on a first one of the linear actuator housing 70 and the outer housing 110, and (2) at least one recess 126 formed on a second one of the linear actuator housing 70 and the outer housing 110. As shown in FIG. 2, the at least one projection 124 is connected to the outer housing 110 and the at least one recess 126 is connected to the linear actuator housing 70. One of ordinary skill in the art would recognize from the present disclosure that this configuration can be reversed and still achieve the same function. The at least one recess 126 is configured to receive the at least one projection 124. As shown in FIG. 2, two sets of two axially spaced apart projections 124 and recesses 126 are provided.

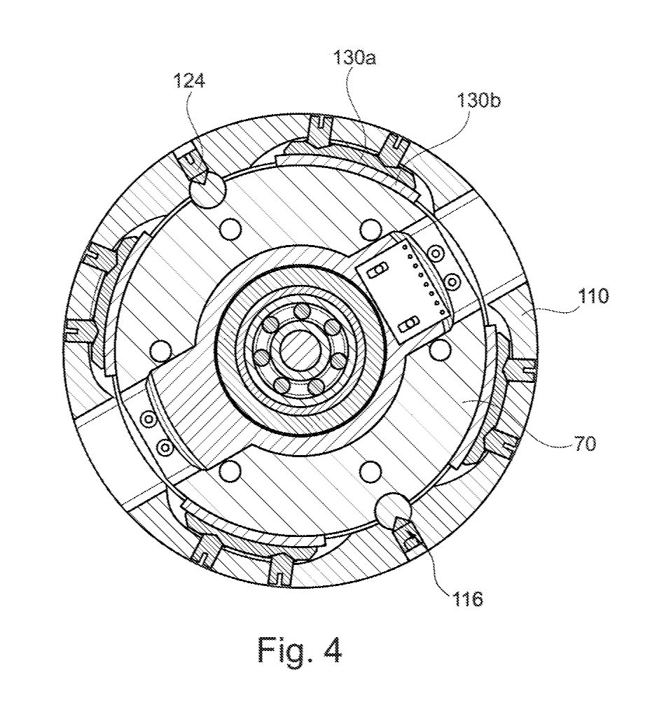

As shown in FIG. 3, a support 128 is provided between the linear actuator housing 70 and the outer housing 110. In one embodiment shown in FIG. 4, the support 128 is a plain bearing including support plates 130a, 130b. In one embodiment, the support surfaces of the plain bearing can include a sliding material, such as a dry lubricant. In one embodiment, the dry lubricant is polytetrafluoroethylene (PTFE) with embedded chemically non-reactive additives. In one embodiment, the bearing surfaces include a steel backing and a sintered porous tin or bronze sliding surface with pores filled with a running-in layer of plastic composite material including PTFE and additives. In another embodiment, the bearing surfaces include a sliding layer of polyoxymethylene (POM). The support 128 provides linear guidance which ensures a smooth axial sliding movement between the linear actuator housing 70 and the outer housing 110. In one embodiment, an anti-friction coating 132 is applied to at least one of a radially inner surface of the outer housing 110 or a radially outer surface of the linear actuator housing 70. An anti-friction coating can be applied to any surface between the linear actuator housing 70 and the outer housing 110 to enable smooth sliding motion between the two housings. In one embodiment, the outer housing 110 includes at least one indentation 138 on an outer upper surface 140.

Having thus described various embodiments of the present linear actuator drive arrangement in detail, it is to be appreciated and will be apparent to those skilled in the art that many changes, only a few of which are exemplified in the detailed description above, could be made in the linear actuator drive arrangement without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

### LOG TO REFERENCE NUMBERS

linear actuator drive assembly 10
drive screw 12
drive screw threading 14
first axial end 16
second axial end 17
motor 20
stator 22
magnets 23
rotor 24
rotor housing 26
first axial end 27
radially inner surface 28
radially outer surface 29
first ring nut 30a
second ring nut 30b
second axial end 31
ring nut grooves 32a, 32b
plurality of planetary screws 34
cage 35
axial ends 36a, 36b
planetary screw grooves 38a, 38b
medial portion 40
planetary screw threading 42
bearing assembly 44
radially inner ring 45a
radially outer ring 45b
encoder ring 50
support ring 52
support shoulder 54
radially inner surface 56
radially inwardly extending flange 58
biasing element 60
linear actuator housing 70
support post 72
linear actuator drive arrangement 100
linear actuator assembly 102
motor 104
drive screw 106
outer housing 110
anti-rotation retainer 112
axial retainer 114
anti-rotation arrangement 116
bolt 118
groove 120
radially outer surface 122
projection 124
recess 126
support 128
support plates 130a, 130b
coating 132
indentation 138
outer upper surface 140

What is claimed is:

1. A linear actuator drive arrangement comprising:
a linear actuator assembly including a motor, a drive screw arranged within the motor that is axially driven by the motor, and a linear actuator housing surrounding the motor;
an outer housing surrounding the linear actuator housing, the outer housing is fixed to the drive screw and axially slides relative to the linear actuator housing when the drive screw is axially driven by the motor; and
an anti-rotation retainer arranged between the linear actuator housing and the outer housing that (1) provides an axial end stop for an extended position of the outer housing located between the outer housing and the linear actuator housing, and (2) prevents relative rotation between the linear actuator housing and the outer housing.

2. The linear actuator drive arrangement of claim 1, wherein the anti-rotation retainer includes a separately formed axial retainer and an anti-rotation arrangement.

3. The linear actuator drive arrangement of claim 2, wherein the axial retainer includes at least one bolt extending radially inwardly from the outer housing into at least one groove defined on a radially outer surface of the linear actuator housing.

4. The linear actuator drive arrangement of claim 2, wherein the anti-rotation arrangement includes (1) at least one projection formed on a first one of the linear actuator housing and the outer housing, and (2) at least one recess formed on a second one of the linear actuator housing and the outer housing, and the at least one recess is configured to receive the at least one projection.

5. The linear actuator drive arrangement of claim 1, further comprising a support between the linear actuator housing and the outer housing.

6. The linear actuator drive arrangement of claim 5, wherein the support is a plain bearing including support plates.

7. The linear actuator drive arrangement of claim 1, further comprising an anti-friction coating applied to at least one of a radially inner surface of the outer housing or a radially outer surface of the linear actuator housing.

8. The linear actuator drive arrangement of claim 1, wherein the outer housing includes at least one indentation on an outer upper surface.

9. The linear actuator drive arrangement of claim 8, wherein the at least one indentation has a concave profile.

10. A linear actuator drive arrangement comprising:
a linear actuator assembly including a motor, a drive screw arranged within the motor that is axially driven by the motor, and a linear actuator housing surrounding the motor;
an outer housing surrounding the linear actuator housing, the outer housing is fixed to the drive screw and axially slides relative to the linear actuator housing when the drive screw is axially driven by the motor, the outer housing includes at least one indentation on an outer upper surface;
a support arranged radially between the linear actuator housing and the outer housing; and
an anti-rotation retainer arranged between the linear actuator housing and the outer housing that (1) provides an axial end stop for an extended position of the outer housing located between the outer housing and the linear actuator housing, and (2) prevents relative rotation between the linear actuator housing and the outer housing;
the anti-rotation retainer includes a separately formed (a) axial retainer and (b) an anti-rotation arrangement,
the axial retainer includes at least one bolt extending radially inwardly from the outer housing into at least one groove defined on a radially outer surface of the linear actuator housing; and
the anti-rotation arrangement includes at least one projection formed on a first one of the linear actuator housing and the outer housing, and at least one recess formed on a second one of the linear actuator housing and the outer housing, and the at least one recess is configured to receive the at least one projection.

11. The linear actuator drive arrangement of claim 10, wherein the support is a plain bearing including support plates.

12. The linear actuator drive arrangement of claim 10, further comprising an anti-friction coating applied to at least one of a radially inner surface of the outer housing or a radially outer surface of the linear actuator housing.

13. The linear actuator drive arrangement of claim 11, wherein the at least one indentation has a concave profile.
